(19) United States
(12) Patent Application Publication
(10) Pub. No.: US 2017/0261951 A1
(43) Pub. Date: Sep. 14, 2017

(54) ADAPTABLE ENERGY MANAGEMENT SYSTEM AND METHOD

(71) Applicant: KABUSHIKI KAISHA TOSHIBA, Tokyo (JP)

(72) Inventors: Ayomi BANDARA, Bristol (GB); Saraansh DAVE, Bristol (GB); Mahesh SOORIYABANDARA, Bristol (GB); Timothy Adrian LEWIS, Bristol (GB)

(73) Assignee: KABUSHIKI KAISHA TOSHIBA, Tokyo (JP)

(21) Appl. No.: 15/125,447

(22) PCT Filed: Jul. 21, 2014
(86) PCT No.: PCT/GB2014/052228

§ 371 Date: Sep. 12, 2016

(51) Int. Cl. G05B 15/02; H02J 13/00

(52) U.S. Cl. CPC G05B 15/02; H02J 13/001; H02J 13/0062; G06Q 50/06

(57) ABSTRACT

The embodiments relate to an adaptive energy management system (AEMS) for monitoring an environment, the AEMS comprising a behaviour analysis module communicatively coupled via a wired or wireless network to a plurality of sensors in the monitored environment and connected to a user interface. The sensors are preferably capable of continuously monitoring one or more conditions of the monitored environment and/or the operation of one or more devices in the monitored environment and providing data regarding said operation to the behaviour analysis module. The behaviour analysis module includes an activity based analysis component that is configured to generate an activity based behaviour pattern for the occupant(s) of the monitored environment based on the data received from the sensor(s), said activity based behaviour component being further configured to adapt said activity based behaviour pattern based on updated data received from said sensor(s). The behaviour analysis modules also includes personality based analysis component that is configured to generate a personality based behaviour pattern for said occupant(s) by applying a behaviour framework to stored data relating to the personality and/or attitudes of the occupant(s), said personality based behaviour component being further configured to update said behaviour framework to be applied based on one or more signals received from the user interface, and to adapt said personality based behaviour pattern based on the updated behaviour framework. The AEMS comprises a control system communicatively coupled to said plurality of sensors for receiving said data on said devices, the control system being arranged to store and generate rules for managing the operation of said devices and the control system being communicatively coupled to the behaviour analysis module for receiving behaviour profile(s) of the occupant(s) based on said generated activity based behaviour pattern and personality based behaviour pattern. The control system further comprises an inference engine configured to automatically infer an optimal action based on said rules and said behaviour patterns, and to generate a control signal for implementing said action on one or more of said devices or on the user interface.

### FIELD

The embodiments relate to energy management systems and methods and more particularly to Smart meters and Smart energy monitoring devices for environments such as homes, building complexes, vehicles etc.

### BACKGROUND

All residential and commercial buildings have one or more types of utility services provided to the building, such as electricity, gas and water etc. While some utilities are charged at fixed prices, it is common for such utilities to be charged with respect to specific usage amounts. Utility meters are provided in order to measure usage of a particular utility within a home, office or industrial building. Smart metering is well known and smart meters allow opportunities to collect and store information (such as power consumption) from a utility grid at household level for instance, with increased granularity. A smart meter is typically an advanced meter (usually an electrical meter, but could also be integrated or work together with gas, water and heat meters) that measures energy consumption in much more detail than a conventional meter. Smart meters are expected to provide accurate readings automatically and at requested time intervals to a utility company, electricity distribution network or to the wider smart grid.

Some existing in-home energy managing systems and metering systems provide feedback to energy consumers regarding their energy usage via a display. Whilst these provide an important direction in reducing the household energy consumption, these systems require the consumers or end users to be constantly engaged with the system and to take some manual action to carry out any changes in the system settings. Research undertaken by the inventors has shown that the usage and user interest on such existing systems has reduced over time because of the amount of involvement required by the user. Hence there exists a need for an automatic energy management and control system and method for homes and other buildings that is capable of an adaptive operation based on behaviour patterns of the occupants.

### BRIEF DESCRIPTION OF THE DRAWINGS

FIG. 1 depicts the extent of user engagement with some existing Smart Home systems.

FIG. 2 is a diagram showing the components of an automatic Adaptive Energy Management System (AEMS) according to the present embodiments, and the interrelation between components for monitoring an environment.

FIG. 3 is a flow diagram depicting activity-based behaviour analysis the AEMS.

FIG. 3a shows one possible implementation for performing activity-based behaviour analysis.

FIG. 4 is an example of a probability distribution indicating usage of energy consuming devices in the monitored environment.

FIGS. 5 and 6 are flow diagrams showing the steps for automatically inferring personality based behaviour patterns by the AEMS.

FIG. 7 shows a flow chart depicting feedback provided by the AEMS based on the inferred behavioural patterns.

FIG. 8 is a flow diagram showing the process for choosing an intervention or action to be implemented based on user interaction in response to feedback of FIG. 7.

FIG. 9 is a representation of difference in behavioural patterns of an end user relative to the subjective norm i.e. peer influenced behaviour.

FIG. 10 is a representation of the operation of the AEMS for monitoring a home energy environment, in a first example.

FIG. 11 is a representation of the operation of the AEMS for monitoring a moving vehicle, in a second example.

FIG. 12 is a flow diagram showing for the operation of the AEMS for monitoring appliance patterns.

### DETAILED DESCRIPTION

An objective of the described embodiments is to provide a system and method for automatic energy management and control, capable of an adaptive operation based on behaviour patterns of the occupants.

In one aspect the described embodiments provide an adaptive energy management system (AEMS) for monitoring an environment, the AEMS comprising:

a behaviour analysis module communicatively coupled via a wired or wireless network to a plurality of sensors in the monitored environment and connected to a user interface, the sensors being capable of continuously monitoring one or more conditions of the monitored environment and/or the operation of one or devices in the monitored environment and providing data regarding said operation to the behaviour analysis module, said behaviour analysis module including:

an activity based analysis component that is configured to generate an activity based behaviour pattern for the occupant(s) of the monitored environment based on the data received from the sensor(s), said activity based behaviour component being further configured to adapt said activity based behaviour pattern based on updated data received from said sensor(s), and

a personality based analysis component that is configured to generate a personality based behaviour pattern for said occupant(s) by applying a behaviour framework to stored data relating to the personality and/or attitudes of the occupant(s), said personality based behaviour component being further configured to update said behaviour framework to be applied based on one or more signals received from the user interface, and to adapt said personality based behaviour pattern based on the updated behaviour framework;

a control system communicatively coupled to said plurality of sensors for receiving said data on said devices, the control system being arranged to store and generate rules for managing the operation of said devices, the control system being communicatively coupled to the behaviour analysis module for receiving behaviour profile(s) of the occupant(s) based on said generated activity based behaviour pattern and personality based behaviour pattern, the control system further comprising an inference engine configured to automatically infer an optimal action based on said rules and said behaviour patterns, and to generate a control signal for implementing said action on one or more of said devices or on the user interface.

In a further aspect, the described embodiments provide a method for providing an adaptive energy management system for monitoring an environment, the method being capable of implementation in the system claimed in any one of the preceding claims, the method comprising the steps of:

providing a behaviour analysis module that is communicatively coupled to a plurality of sensors and a user interface, the sensors being capable of continuously monitoring one or more conditions of the monitored environment and/or the operation of devices in the monitored environment and providing data regarding said operation;

generating an activity based behaviour pattern for the occupant(s) of the monitored environment by an activity-based behaviour component, said pattern being based on the data received from the sensor(s), said activity based behaviour component configured for adapting said activity based behaviour pattern based on updated data received from said sensor(s);

generating a personality based behaviour pattern for said occupant(s) by applying a behaviour framework to stored data relating to the occupant(s) personality and/or attitudes by a personality based analysis component, said personality based behaviour component configured for updating said behaviour framework to be applied based on one or more signals received from the user interface, and for adapting said personality based behaviour pattern based on the updated behaviour framework;

proving a control system communicatively coupled with the plurality of sensors for receiving data on the one or more devices, said control system providing the further steps of:

storing and generating rules for managing the operation of said devices,

receiving behaviour profile(s) of the occupant(s) based on said generated activity based behaviour pattern and personality based behaviour pattern;

providing an inference engine for inferring an optimal action based on said rules and behaviour patterns, the inference engine further configured for generating a control signal for implementing said action on one or more said devices or the user interface.

Specifically, the embodiments relate to an adaptive energy management system (AEMS) for a monitored environment and a method for automatically inferring changes in occupant's behaviour patterns and adapting the operation of one or more devices that control the conditions of the monitored environment based on the inference made. This inference is provided by an inference engine within a control system of the AEMS. Occupancy patterns are mostly based on the behaviour and the preferences or personalities of the occupants in a home. Though the foregoing description makes reference to energy management systems in a home environment or a household, the present invention is not to be considered as being limited to this. This invention applies to other buildings, office spaces, industrial complexes, warehouses etc. The AEMS of the described embodiments is capable of controlling the operation of one or more devices that have an effect on the condition of the monitored environment and/or controlling and regulating the energy supply to the environment being monitored, and/or minimising the energy consumption without compromising on occupant comfort. In the AEMS of the described embodiments, the rules are defined and used to control operation of energy consuming devices such as electrical appliances, heaters, air conditioning units etc., other devices such as blinds, screens, vehicle control, car windows, sprinkler systems, water supply controls, humidifiers/dehumidifiers. The operation of such devices that have any effect on, or control the monitored environment can be adapted to the inferred changing user preferences or behaviour patterns. The devices that can be controlled are not limited to the above, and can include a wide range of appliances that can be connected to the AEMS. Also the inference engine of infers changing user attitudes related to one or more factors influencing energy consumption and adjusts the operation of the AEMS accordingly. Information relating to user attitudes towards one or more factors can be initially collected and stored in the AEMS as reference data, which is then adjusted based on an inference that one or more such attitudes has changed.

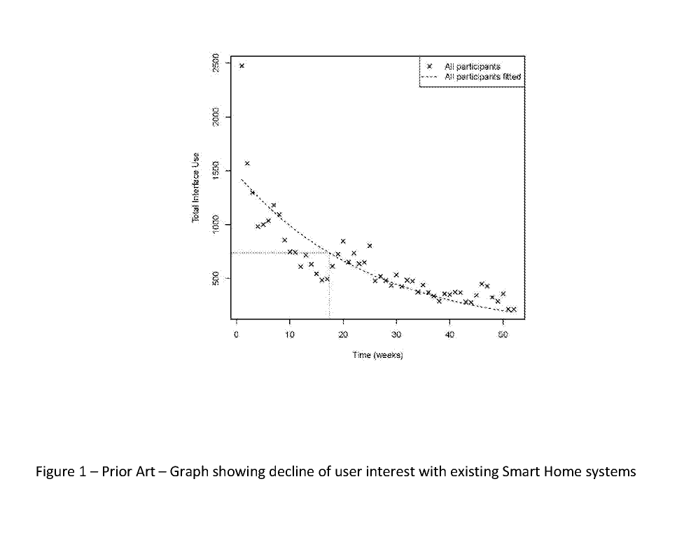

There are a number of existing research efforts that proposes to use artificial intelligence in energy management systems in order to automate energy management. These existing techniques do not consider occupant's behaviour and therefore the consumer ultimately loses out on potential energy savings. For instance, in one existing product the concept of statistical analysis is proposed that is to be fed back to an energy grid that may be a smart grid. Another existing product provides feedback to a user regarding the energy consumption in the household. As mentioned above in the Background section, Research has shown that the usage and user interest on these existing systems that simply display feedback information has reduced over time, because of the amount of manual engagement and involvement required by the user to facilitate any change to the set energy management rules and policies. See the graph shown in FIG. 1 illustrating this declining interest. These existing smart energy management approaches do not integrate mechanisms for energy managements using such behaviour analysis and learning. Also, the existing approaches do not consider behavioural aspects such as personal preferences, attitudes and opinions of the occupants of the monitored environment. The existing approaches do not employ any mechanism whereby the rules can be adapted to changing user preferences or behaviour. Furthermore, existing systems do not have a mechanism to take into consideration the users' attitudes during initialisation so that the rules for controlling the operation of one or more devices that affect the conditions of a monitored environment can be personalised to a certain extent.

Operation of the Adaptable Energy Management System (AEMS) of the described embodiments:

The embodiments described herein relate to an intelligent adaptable energy management system (AEMS) for smart homes as shown in FIG. 1. The AEMS 2 is communicatively coupled to one or more sensors 2.14 that sense and transfer information relating to the state or condition of the monitored environment and/or the energy usage of one or more appliances in the household. The sensors may also include actuators for triggering the supply of energy, i.e. such as in the form of current, to the appliances. The sensors may also include means for monitoring the supply of water, gas, power, heat, air etc.

Some example of devices in an environment that can be monitored by the sensors 2.14 may be energy consuming appliances such as heaters, lights, air conditioners and some kitchen appliances etc. that use energy in the form of electricity or gas. Examples of other appliances may not be energy consuming i.e. automatic blinds etc. but their operation may be controlled or triggered by an actuator or electrical switching circuit based on the state or condition of the monitored environment, as sensed by the sensors 2.14, or may be based on the operation of one or more energy consuming devices. Therefore, although the below detailed description of a preferred embodiments relates to an Adaptive Energy Management Systems (AEMS) that controls the operation of energy consuming devices that have an effect on a monitored environment; a skilled person would infer that such an AEMS may be utilised to control the operation of other devices (not dependent on energy supply) based on the condition of the monitored environment as sensed by sensors. The devices that are in communication with the AEMS may be controlled by a hardware/software actuation mechanism and/or based on control signals generated by the AEMS.

This information from these sensors is preferably stored in a historical sensor data base 2.4 that may be incorporated within the AEMS 2 or externally connected to it. Another database that is accessed by the AEMS 2 is the User data database 2.2. Data relating to the occupants of the household is stored here. This data base 2.2 is arranged to store profile information of the occupants, which may have been stored prior to the installation of the AEMS 2 in the household. Such information may relate to basic information regarding user patterns and attitudes, such as whether they are energy conscious or comfort conscious, their preferences for power down/standby modes etc. This initial information can be collected from surveys or questionnaires provided to the occupants and this user data can be used as reference data by the AEMS 2.

The AEMS 2 system includes an analysis model 2.6 that is capable of using the information from the historical sensor data database 2.4 and the user data base 2.2 to identify occupants' behaviour patterns, therefore performing behaviour profiling for the one or more occupants of the household. The analysis component 2.6 includes an activity-based behaviour analysis component 2.6a that monitors the behaviour patterns of the occupants based on their activity patterns. This relates to the occupants' patterns relating to occupancy, sleeping, appliance usage and periodic routines. This is obtained from the data collected from the sensors 2.14. The analysis component 2.6 also includes a personality-based behaviour analysis component 2.6b. This component is responsible for tracking specific attributes about an occupant's behaviour such as opinions, attitudes, preferences etc. relating to one or more behaviour influencing factors. This component 2.6b performs personality-based profiling using the user database 2.2 as well as input received following user interaction with a user interface (not shown in FIG. 1) and/or display device in the AEMS 2. The profiles and parameters from the activity based and personality based analysis components i.e. the analysis output 2.6c, is capable of being packaged in a suitable format and transferred to the AEMS 2, which allows the system to adapt to changing user behaviours.

The AEMS 2 further comprises a control module 2.8. This module is communicatively coupled to the sensors and appliances 2.14 as well as to a display device on the user interface provided for the AEMS 2. The control module 2.8 includes a Smart Home inference engine 2.10. This inference engine is coupled to a Smart home knowledge base 2.12a. This database describes the knowledge (relevant to the home environment being monitored) in a suitable format. This knowledge base 2.12a obtains input from the sensors 2.14 and the behaviour analysis component 2.6. Knowledge base 2.12a will represent all relevant information pertaining to the home environment, which includes appliance information, occupant information, weather data, environment conditions, utility provider details etc.

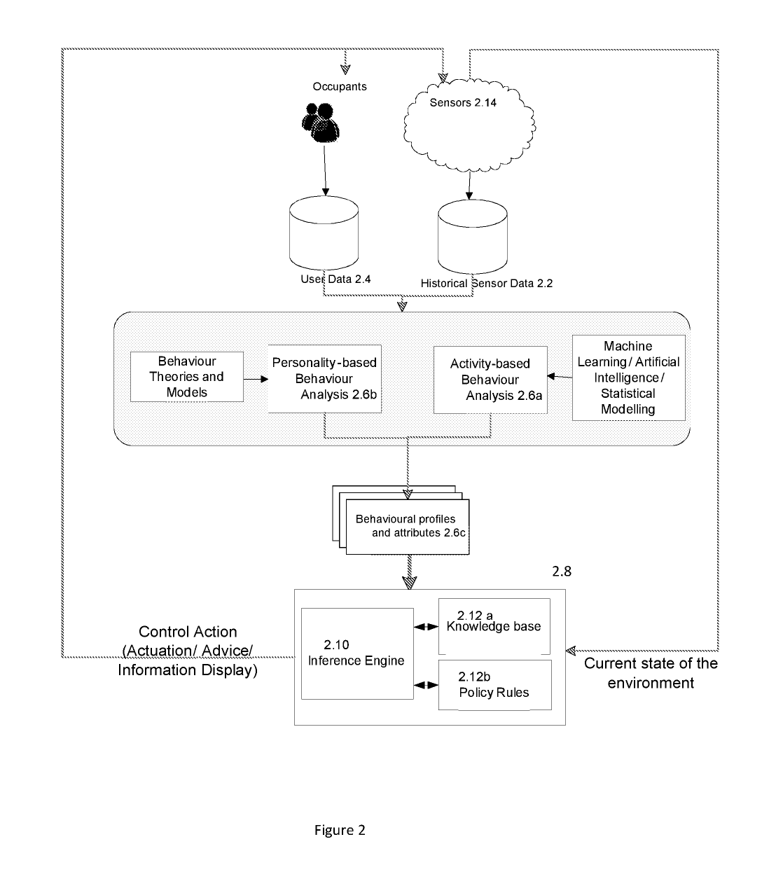

Rules and/or home automation strategies and/or predefined policies (including energy management policies for the household) capable of being applied by the AEMS 2 for execution upon one or more conditions is preferably provided in a Smart Home Policy Rules module 2.12b, also called policy or rules module 2.12b, which may be separate to or integrated with the knowledge base 2.12a. The aims of the defined rules in the policy/rules module 2.12b include, but are not limited to improving energy efficiency, maintaining the user comfort, assisting users in their daily activities and maintaining health and wellbeing. The knowledge base 2.12a preferably includes the current state of the environment (for instance occupancy, appliance states, temperature and other weather related data and also preferences and attitudes) and is arranged to access the policy rules 2.12b that indicate a defined action to be taken. In the AEMS 2, these rules and policies will be influenced by the input from the behaviour analysis module 2.6. Based on the information from both the Smart Home knowledge base 2.12a and the policy rules module 2.12b, as well as the behaviour patterns from the analysis module 2.6, the inference engine 2.10 is arranged to infer the most appropriate action by the AEMS 2. The recommended action may be actuation of appropriate devices or generating tips/advice/information to be displayed for the user. As shown in FIG. 2, the inference engine will communicate with the knowledge base 2.12a and the rules components 2.12b, and will also consider the behaviour profiles and attributes 2.6c, and will evaluate the prescribed rules to find out the need for any control actions to take place under the current state of the environment.

Activity-Based Behaviour Analysis:

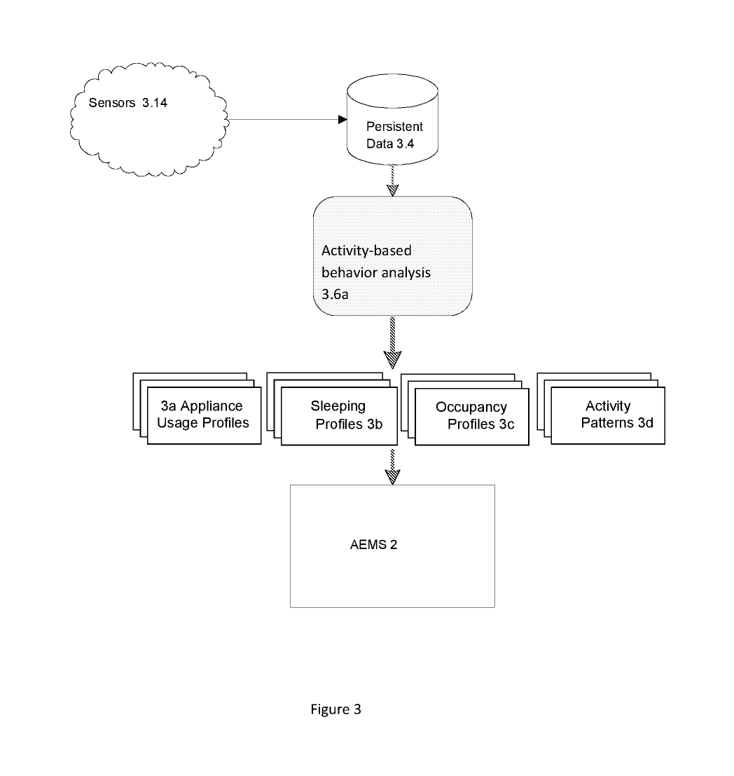

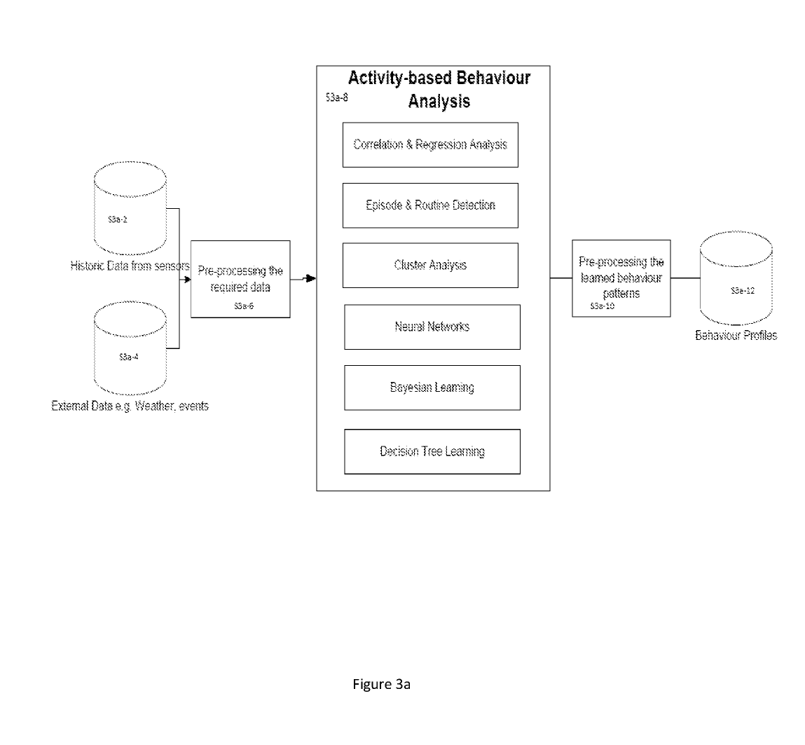

The Activity-based Behaviour Analysis Component 3.6a is also shown in FIG. 3. This component 3.6a makes uses the sensor data gathered over time (Persistent data 3.4) from presence sensors, energy use sensors, temperature sensors, light sensors etc., and incorporates machine learning/statistical modelling techniques to develop and construct activity based behaviour profiles, which can be used and adapted over time for further use. This process is illustrated in FIG. 3. Specifically the components of the activity-based analysis component 2.6a will include, but not limited to:
Appliance Usage patterns (3c): These will indicate the times that the users will use different appliances in the house and their likelihood of being used. These can be constructed for different days of a cycle, typically a week.
Sleeping patterns (3b): The times when the occupants are likely to be sleeping for different days.
Occupancy profiles (3a): which will have occupancy patterns that indicate the times each room in the house is occupied and the likelihood of occupancy. This can be constructed on different days of the week.
Periodic routines of occupants, i.e. Activity Patterns (3d): These will indicate the activities an occupant will carry out daily/weekly/monthly and so on.

Such patterns are learned and will be used as parameters for the Rules/Policy module (2.12b shown in FIG. 2). The inference engine 2.10 is then arranged to issue executable control actions based on the patterns/profiles (3.6 a-d) that complement the behaviours and preferences of the occupants.

The information flow diagram in FIG. 3a shows an example implementation of the activity-based behaviour analysis component 3.6a may. Information can be gathered or produced for activity-based analysis based on historical sensor data, as seen step S3a-2, and/or from sensor data relating to external factors such as the weather conditions, sunlight, etc. as shown in S3a-4. The gathered data may then be processed in step S3a-6 or managed by known data processing operation. For instance, such processing may include pre-processing operations to process the gathered data into a standard format or parse the data into a standard data structure such that the information gathered may be used or manipulated in the same way.

The activity-based behaviour analysis in step S3a-8 can take place on the available data using one or more learning algorithms techniques for manipulating the available data. Some examples of analysis techniques and leaning processing shown in S3a-8 include, but are not limited to the use of processes and algorithms that perform:

Correlation and Regression analysis

Episode and Routine analysis

Cluster analysis

Neural networks

Bayesian learning algorithms

Decision tree based learning techniques

The outcome of the one of more analysis techniques in S3a-8 will be one or more learned activity-based behaviour patterns. These patters may then, if required, be subject to further processing steps. This may be required if these learned patterns are to be placed in a particular or standard format before it can be used to create occupants' behaviour profiles. This is shown in step S3a-10. The behaviour patterns and/or the behaviour profiles are preferably stored in a database as shown in S3a-12, as flat files, or stored using other storage means.

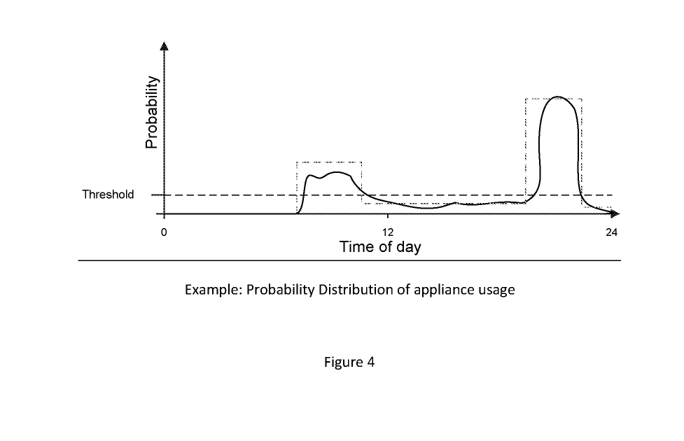

A particular use of activity-based behavioural analysis in FIG. 3 and FIG. 3a is to detect appliance usage patterns and switching devices on/off accordingly to save energy and also to increase user satisfaction. For example, through activity-based behaviour analysis 3.6, the system could identify patterns for the usage times of each individual appliance in the house for different days. A graph representing probability distributions that indicate the usage times is shown in FIG. 4. Through these probability distributions, if the control system 2.8 (shown in FIG. 2) infers that between the hours of 8 am and 5 pm, the likelihood of using the television (and other entertainment appliances like DVD player, Set top box etc. and also appliances like microwave oven) is less than a certain threshold (0.1 for example), the inference engine 2.10 can generate control signals to switch off the appliances from “stand by” state so that the energy levels are saved. In time intervals where the likelihood of use is high, the system can power on these devices to the “stand by” state so that the users can immediately start using these appliances when needed. Thus, from this use case it is evident that the AEMS 2 of the described embodiments operates to ensure that energy is saved where possible and also user comfort is taken care of.

In another example, the control system 2.8 shown in FIG. 2 can utilise the occupants' sleeping patterns 2.6a to control lighting in the house or the use of occupancy profiles to control the heating systems.

Personality-Based Behaviour Analysis:

The Personality-based behaviour analysis component 2.6b of the AEMS 2 of FIG. 2, takes into account personality/psychological aspects of behaviour such as attitudes, opinions, preferences and other personal data such as demographics. Initially, user data (relating to demographics, attitudes, opinions and preferences) that can be used as reference data to initialise this component 2.6b may be predefined in the user database 2.4. This information may be provided by the users beforehand, such as from the information gathered through questionnaires or any other means of obtaining required data relating to the occupants' personalities. Accepted behaviour theories, for example the Theory of Planned Behaviour (Ajzen 1991), may be used to infer personality and behavioural attributes for the occupants, which is then provided as input to the control system 2.8 for adapting the knowledge base 2.12a and policy/rules module 2.12b such that the inference engine 2.10 automatically infers the energy saving advice and actions that are most suitable relative to the initially stored user preference. The inference engine can then adapt the display of such inference and actions such that these advice/information displays will have maximal influence on the occupants. For example, the above mentioned accepted Theory of Planned Behaviour can identify a person to be highly influenced by their peers. This personality information can then be used to display information comparing them to their neighbours (e.g. your consumption is 10 units but your neighbourhood average is 8 units).

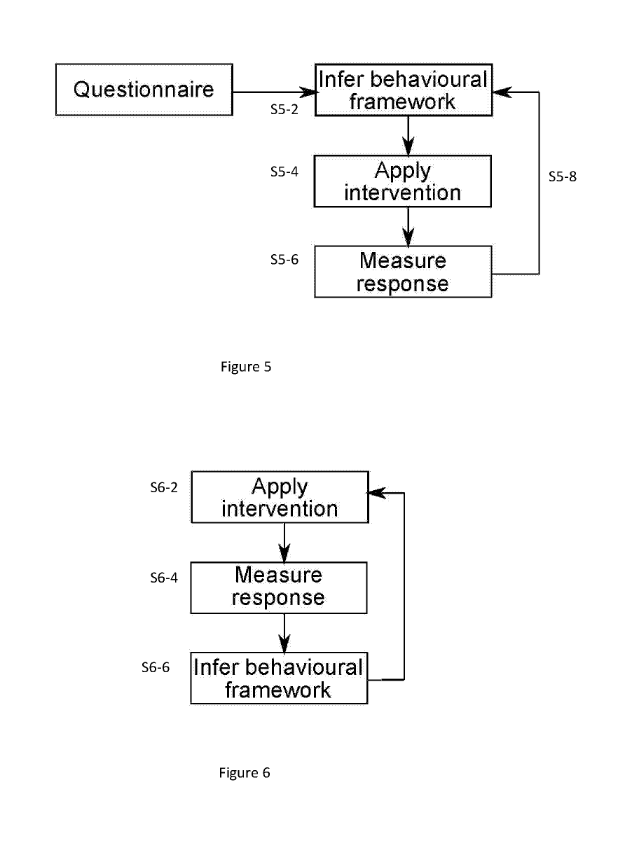

FIG. 5 shows an example of the operation of the AEMS 2 using the personality profiles and patterns constructed by the personality-based behaviour analysis component 2.6b. As mentioned above, this component 2.6b can collect user data through questionnaires and gather information relating to demographics, attitudes, opinions and preferences as indicated in Step S5-2 in FIG. 6. This information can then be used to infer an initial behaviour framework or model for applying to the user data in order to generate a personality based behaviour pattern. This is customised to the user data and allows the AEMS to take the most appropriate action, as seen in step S5-4. This step preferably makes use of accepted behaviour theories and models (this includes, but not limited to the Theory of Planned Behaviour) for the framework that is to be applied and infers the necessary personality based behavioural attributes and patterns. This step S5-4 facilitates or customises the energy saving advice that can be triggered by the inference engine 2.10, as well and other information displays on a display device on a user interface based on the user's personality. The inference engine 2.10 operates such that the advice/information displays will have maximal influence on the individual occupants, according to the behaviour profiles 2.6c. The inference engine triggers control signals such that AEMS 2 provided the user with feedback regarding changes relating to the supply of energy to one or more appliance. This feedback or action is provided such that user action or inaction following the display of information is measured, as seen in step S5-6. Based on this measured user response or inaction, the profile and patterns that are based on the user's personality and attitude to one or more factors will be updated and adapted accordingly, as shown in Step S5-8.

Another technique for adapting the AEMS 2 based on user personalities is shown in FIG. 6. Here, instead of triggering feedback to be displayed to the occupants, the inference engine simply issues a control signal to activate, deactivate or change the supply of energy to one or more appliance in the household based on existing rules in the policy or rules module 2.12b. This seen Step S6-2, wherein the intervention is first applied. Once this action is taken by AEMS 2, behaviour changes and user reaction and responses to such change is then measured, as seen in Step S6-4. Based on the user reaction to this intervention, the behavioural framework is then adapted and a new personality based behaviour pattern is created for the occupants. By this, the rules and policies that trigger the inference engine are adapted based on this reaction. This is seen in step S6-6. For instance, consider that an initial policy recommends a winter heating temperature of 22 degrees Celsius, which triggers the heater to supply heat if the temperature falls below 20 degrees. If the AEMS 2 inference engine infers that re-heating the household only after the temperature falls to 18 degrees Celsius can save up to 20% of energy, the inference engine triggers a control signal to supply heat energy to the household only if 18 degrees is reached. If the occupants do not react to this intervention by manually adjusting the settings to be in line with the initial energy policy, then the new policy will be saved and the personality based analysis module will amend the users personality profile to indicate that the user is cautious about energy consumption, and is inclined to be interested in saving energy. If the occupants change settings to be in line with the initial one, then the inference engine understands that the user is more concerned with comfort levels over energy savings and will retain the initial policy or rules, without adapting the energy supply and without recommending further feedback regarding energy savings. Thus, based on these user reactions to automatic actions triggered by the AEMS, the personality based behavioural characteristics can be learned and the behaviour framework can be updated.

Use of learned behaviour patterns for influencing the AEMS:

For example, the 3E-Houses project results, show evidence that behavioural theories (in this case the Theory of Planned Behaviour) can differentiate between high and low energy saving groups. Based on this, the intervention (or feedback device) can be altered to target these specific attributes. For instance, subjective norm (i.e. the degree to which those around you influence your behaviour), which is a constituent of the Theory of Planned Behaviour, can be targeted by displaying messages comparing a households consumption pattern to some average or expected value. This would in effect apply peer pressure on the consumer thus leveraging on the subjective norm characteristic. The AEMS 2 according to the described embodiments will then measure any changes in behaviour due to this, and if satisfactory, will learn to use this technique again to keep adapting the inputs that are provided to the inference engine 2.10. If the response measured is not one that is not expected, the personality based analysis module 2.6b can try to target another behavioural framework, and the policy rules module 2.12b is once again adapted or reverts to the initial policy, before passing the rules to the inference engine 2.10. Conversely, if a householder has got a low measure of subjective norm, comparing their consumption figures with their peers will not be effective.

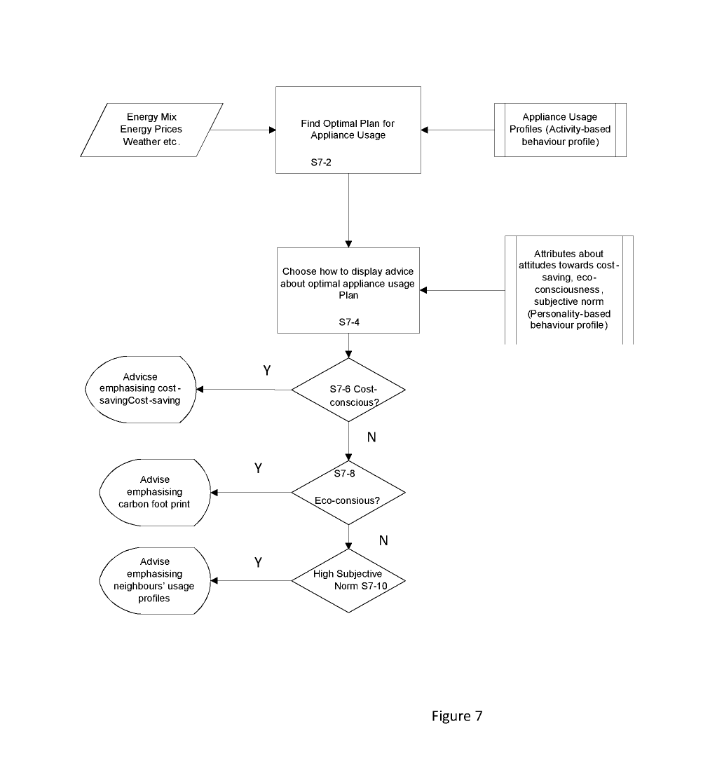

FIG. 7 shows a particular use case of how the different profiles can be combined to enable control action from the inference engine 2.10. In this case, appliance usage profile (which is an activity-based behaviour profile) is analysed to see if this deviates from potential optimal appliance use behaviour. This is shown in Steps S7-2 to S7-4. For instance, for this use case it is assumes that the appliance use profile of an iron in the household may indicate that it is being used every weekday morning and the optimal usage will be to use the iron only weekly on Saturday evening. Depending on the behaviour attributes identified through personality-based behaviour analysis 2.6b in FIG. 2, it is identified whether the occupant is cost-conscious person (S7-6) and eco-friendly person (S7-8) or influenced by peer behaviour (S7-10). The inference engine 2.10 based on this, can find the optimal way to display this advice to the user or adapt the supply to one or more monitored appliances accordingly.

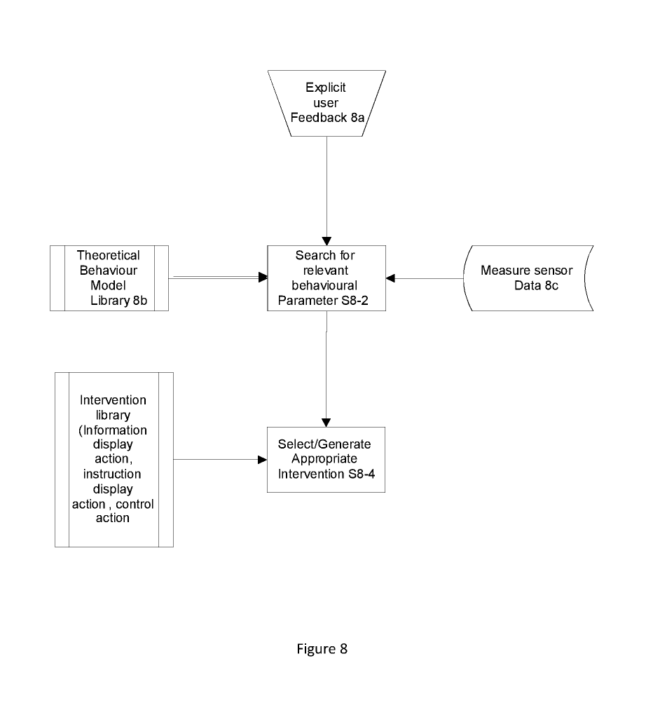

FIG. 8 illustrates the flowchart for choosing the appropriate intervention mechanism depending on the specific personality-based behaviour attributes. As shown in this figure, the relevant attribute or factor of the user or occupant's personality that is to be used as a parameter for the analysis model 2.6 is selected based on a plurality of sources, as seen in S8-2. This can be from user feedback via the display or user interface as seen in 8a. In addition to or alternatively, this can also be from a manual adjustment of the energy supply to appliances as seen in 8b, and or from the library of theoretical personality based behaviour model, such as in 8c. 8c may be used mostly for initialising the personality profiles of the household occupants. Based on this, the appropriate intervention action is selected by the intelligent inference engine 2.10, as seen in step S8-4. Here, the inference engine 2.10 also preferably considers data from an intervention library 8d recording the history of previous interventions, actions and responses from the occupants, prior to making an intelligent inference on the best action or intervention at the given instance. Other inputs and patterns can also be considered in FIG. 8 and the proposed personality based adaptation functionally of the AEMS 2 can be implemented in different ways and need not be limited to the particular techniques, methods and models described herein.

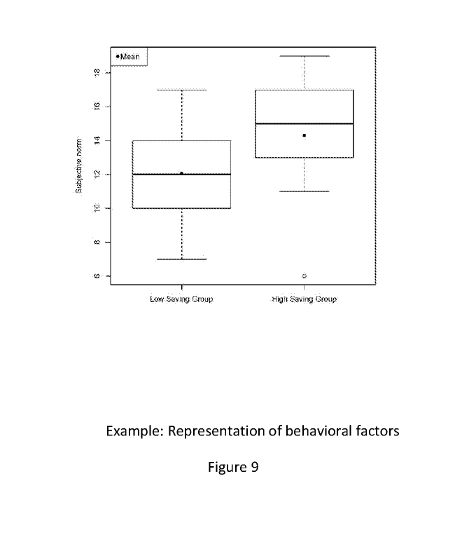

Personality based behaviour analysis 2.6b builds on a large bed of behavioural psychology and behavioural economics within the energy and health domain to create targeted feedback messages or graphics within the AEMS 2. As consumers can be influenced based on how a message or information is presented, the described embodiments presents an empirically based way of doing this. For example, FIG. 9 shows a certain behavioural factor for low and high energy saving groups. The behavioural factor, subjective norm, is significantly different for each group. This insight can be used to tailor information for each set of households by the behaviour analysis module 2.6 of the AEMS 2.

From the foregoing description it will be understood that the proposed approach and AEMS 2 aims to provide an intelligent adaptable energy management system capable of taking appropriate control actions without the need of user intervention to continuously adapt the system according to their requirements. The control action by the inference engine 2.10 can be either actuation of relevant devices or the display of advice/information. Most importantly, the method takes into consideration the user behaviours and preferences in two stages:

Stage 1: By including an initialisation phase where the user preferences, expectations and other personal data are captured through user questionnaires and an optimum initial configuration is set

Stage 2: By including behaviour analysis functionality in the system which constantly senses the environment and behaviour of occupants to generate behaviour profiles, thus making the overall system adaptable to changing occupant behaviours.

The purpose of the proposed two stage approach is to provide systems and methods to realise smart homes monitored by the AEMS 2 with the target of saving energy, improving user comfort, assisting users in their daily activities and maintaining their health. Since the AEMS 2 captures knowledge of all the relevant facts in its knowledge base 2.12b and the appropriate strategies in the policy or rules module 2.12b, the inference engine 2.10 will intelligently infer the best control actions to take in different circumstances, without needing any user involvement. Therefore the automation/energy management actions and strategies in the control system 2.8 are capable of customising and adjusting to changing user behaviours.

Specific Use Cases and Examples incorporating AEMS according to the described embodiments:

There can be many ways of implementing the proposed solution and some example cases are given below.

### Example 1

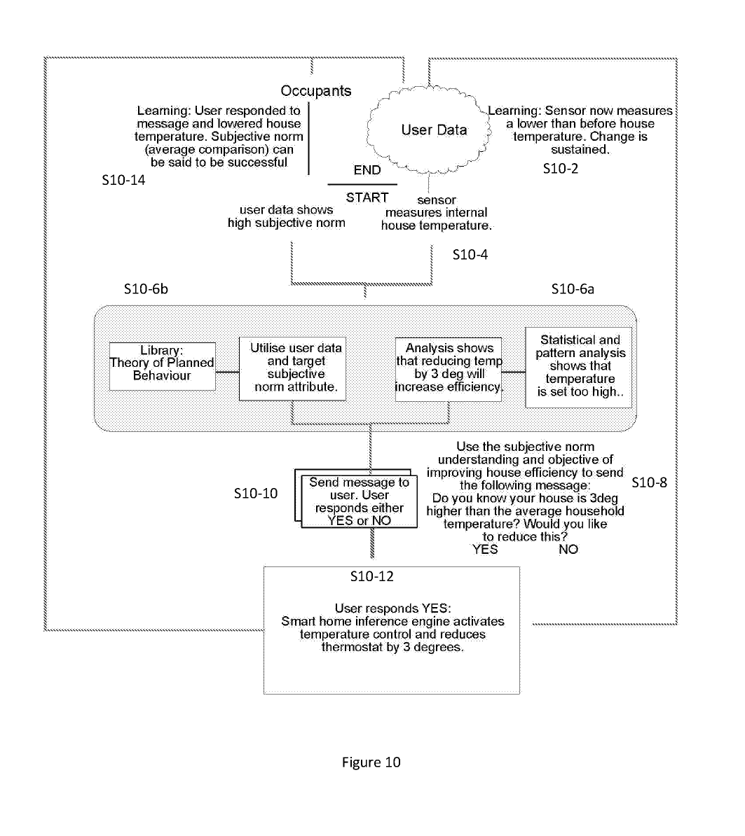

FIG. 10 shows a first example where the AEMS according to the described embodiments can be used in a home energy management system environment. In step S10-2, a sensor detects and measures internal house temperature whilst the user information (could be collected through a questionnaire) includes personality attributes. The temperature sensor information is then analysed through statistical and pattern detection methods in step S10-4. It is assumed for this scenario that the household temperature is 3 degrees above the average temperature of a similar household. The analysis finds that a reduction in temperature of 3 degrees will result in greater efficiency for the household, as in step S10-6a. From a personality-based analysis module, a framework library detects that the occupant has a high subjective norm value which should be taken into account when presenting information, as seen in step S10-6b. This allows for an inference that the occupant is greatly influenced by their peers.

The personality analysis shows that the occupant is more likely to respond to peer-influence rather than efficiency saving analysis. Hence the user interface sends a message to a display on the user interface of the AEMS 2 that says: “Do you know your house temperature is 3 degrees higher than the average temperature for a similar household? Would you like to reduce this now?”—This as illustrated in S10-8. The user then can select either YES or NO in response to this in step S10-10.

It is assume in this example that the user has selected YES. Thus the inference engine sends a control signal for automatically reducing the thermostat setting by 3 degrees in step S10-12. The positive reaction to this type of message reinforces the learning of the personality behaviour while the new sensor measurement is at 3 degrees lower. This shows a sustained change in behaviour, as in illustrated in step S10-14.

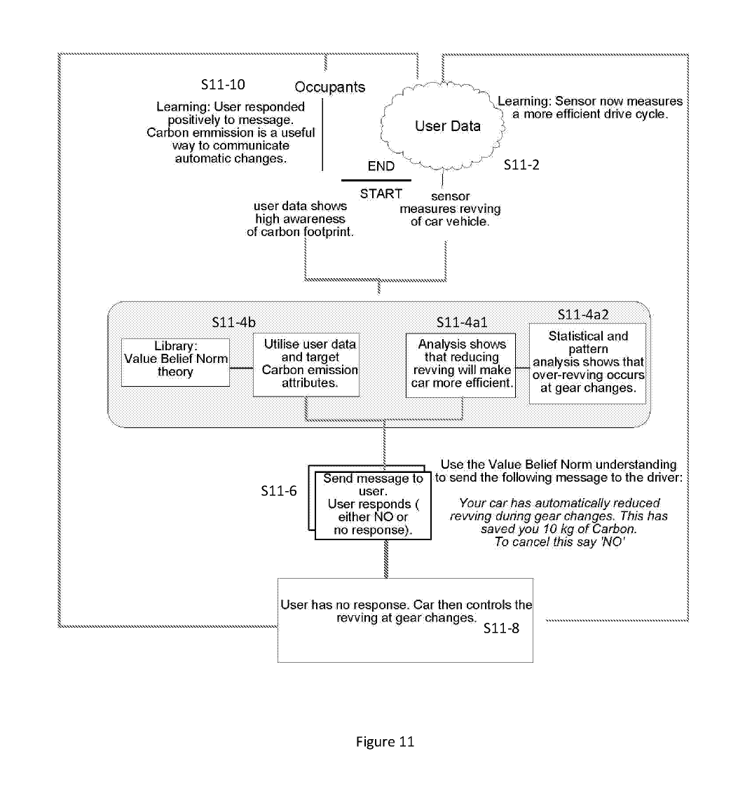

FIG. 11 shows an example of the AEMS 2 according to the described embodiments in a smart car application. A sensor measures the revving of a car in step S11-2, while user personality information is also collected. Statistical and pattern analysis shows that the user over-revs the car during gear changes in step S11-4a1. An analyser then calculates that reducing the engine revving during these periods will significantly improve vehicle performance and economise on fuel in step S11-4a2. The personality based behaviour analysis component 2.6b in the AEMS 2 highlights certain factors of the Value-Belief-Norm theory that are relevant to the driver such as their awareness of Carbon and their Carbon footprint, as illustrated in step S11-4b.

The user interface of the AEMS 2 in the Smart car, upon trigger by the control system 2.8, implements an automatic control on the engine during gear changes and displays the following message to the user: “Your car has automatically reduced revving during gear changes. This has saved you 10 kg of Carbon. To cancel say NO”—this is seen in step S11-6. In this scenario, we assume that the user does not respond, which is learnt by the inference engine 2.10 as being a positive response to the intervention in step S11-8. Thus, by this the personality type of the driver is also reinforced, as this particular message achieved its objective as seen in step S11-12.

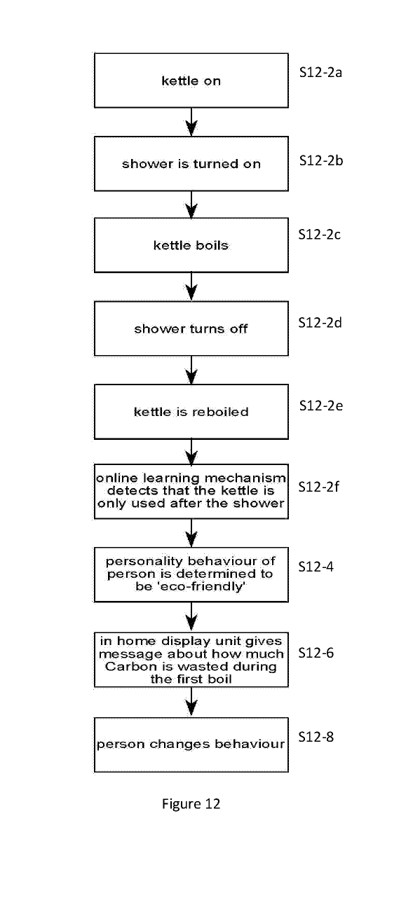

FIG. 12 shows a flowchart of a simple detection and action application within a smart home. In this use case, a kettle is detected as being boiled twice because the user has a shower after switching on the kettle initially, as shown in steps S12-2a to S12-2f. The personality analysis shows that the occupant is aware of their carbon footprint and places a lot of emphasis on these aspects, as seen in step S12-4. By utilising these two pieces of information about the user (kettle boiling inefficiency and carbon awareness), the display on the user interface of the AEMS shows a message stating the carbon impact of boiling the kettle twice instead of just once, as seen in step S12-6. The sensor can then detect (on subsequent days) whether the user responded positively to this message or not. If yes, then the personality profile is reinforced whilst if there was a negative response then the system learns that this is an ineffective intervention. This is illustrated in step S12-8.

While certain embodiments have been described, these embodiments have been presented by way of example only, and are not intended to limit the scope of the invention. Indeed, the novel devices, methods, and products described herein may be embodied in a variety of other forms; furthermore, various omissions, substitutions and changes in the form of the methods and systems described herein may be made without departing from the spirit and scope of the invention. The accompanying claims and their equivalents are intended to cover such forms or modifications as would fall within the scope of the embodiments.

1. An adaptive energy management system (AEMS) for monitoring an environment, the AEMS comprising:
a behaviour analysis module communicatively coupled via a wired or wireless network to a plurality of sensors in the monitored environment and connected to a user interface, the sensors being capable of continuously monitoring one or more conditions of the monitored environment and/or the operation of one or more devices in the monitored environment and providing data regarding said operation to the behaviour analysis module, said behaviour analysis module including:
an activity based analysis component that is configured to generate an activity based behaviour pattern for the occupant(s) of the monitored environment based on the data received from the sensor(s), said activity based behaviour component being further configured to adapt said activity based behaviour pattern based on updated data received from said sensor(s), and
a personality based analysis component that is configured to generate a personality based behaviour pattern for said occupant(s) by applying a behaviour framework to stored data relating to the personality and/or attitudes of the occupant(s), said personality based behaviour component being further configured to update said behaviour framework to be applied based on one or more signals received from the user interface; and to adapt said personality based behaviour pattern based on the updated behaviour framework;
a control system communicatively coupled to said plurality of sensors for receiving said data on said devices, the control system being arranged to store and generate rules for managing the operation of said devices, the control system being communicatively coupled to the behaviour analysis module for receiving behaviour profile(s) of the occupant(s) based on said generated activity based behaviour pattern and personality based behaviour pattern, the control system further comprising an inference engine configured to automatically infer an optimal action based on said rules and said behaviour patterns, and to generate a control signal for implementing said action on one or more of said devices or on the user interface.

2. The adaptive energy management system of claim 1, wherein said one or more devices in the monitored environment include one or more energy consuming devices, and wherein the control system is further configured to store and generate rules for managing the energy supply to said energy consuming devices.

3. The adaptive energy management system of claim 2 wherein the plurality of sensors include sensors for monitoring the operation of said one or more energy consuming devices, and sensors for monitoring changes to a condition of the monitored environment based on the operation of said energy consuming devices.

4. The adaptive energy management system of claim 1, wherein the control system is configured to compare the data received from the sensors regarding a condition of the monitored environment to a defined value relating to said condition, and wherein the inference engine is further configured to generate a signal for controlling the supply of energy to and/or the operation of one or more said devices based on the result of said comparison.

5. The adaptive energy management system of claim 1, wherein the behaviour analysis module is connected via the network to one or more databases, said databases including a database for historical sensor data being capable of receiving and storing data from a plurality of sensors in the monitored environment, and a database for user data being capable of storing data relating to the occupant(s), said user data being received from a user interface via the network; wherein said activity based analysis component is further configured to generate the activity based behaviour pattern based on the historical sensor data, and the personality based analysis component is configured to update said behaviour framework based on the user data relating to the occupant(s) personality and attitude to one or more behaviour influencing factors.

6. The adaptive energy management system of claim 1, wherein the control system further comprises a knowledge base that includes data regarding all the devices within the monitored environment and a policy or rules engine that is arranged to store and generate the rules for managing the operation of one or more of said devices based on a defined energy management policy.

7. The adaptive energy management system of claim 1, wherein the activity based behaviour analysis component is further configured to analyse the data received from the sensors and/or or the database for historical sensor data and to generate appliance usage profiles for one or more said devices and a plurality of activity profiles based on the actions of the occupant(s).

8. The adaptive energy management system of claim 7 wherein the appliance usage profiles indicate the days and/or times representing the maximum and minimum usage of the device, and wherein the activity based behaviour analysis module is arranged to generate a usage pattern using probability distribution of said usage.

9. The adaptive energy management system of claim 7 wherein the activity profiles include sleeping profiles, occupancy profiles and activity patterns of the occupant(s) of the monitored environment.

10. The adaptive energy management system of claim 1 wherein the personality based behaviour analysis component is further configured to apply a predefined or reference behaviour framework to user data from the database to generate an initial personality based behaviour pattern for the occupants(s), such that the inference engine generates the control signal to implement the inferred optimal action based on said initial pattern.

11. The adaptive energy management system of claim 10, wherein based on a user response provided on the user interface or based on a sensed user-reaction following the action taken by the inference engine, the personality based behaviour analysis component is further configured to update the user data in the database and adapt or replace reference the initial behaviour framework so that the adapted framework is based on said user response, such that the adapted framework is then applied by the personality based behaviour component.

12. The adaptive energy management system of claim 1, wherein the control signal generated by the interference engine is arranged to activate or deactivate one or more devices in the monitored environment, or to regulate the supply of energy to device(s), or to display feedback regarding the inferred action to the occupant on a display device on the user interface.

13. The adaptive energy management system of claim 12 wherein, the feedback provided on the display device is adapted based on the personality based behaviour pattern generated by the personality based behaviour analysis component.

14. The adaptive energy management system of claim 1 wherein the monitored environment is a home environment or an office or a building complex or an industrial workshop.

15. A method for providing an adaptive energy management system for monitoring an environment, the method being capable of implementation in the system claimed in any one of the preceding claims, the method comprising the steps of: providing a behaviour analysis module that is communicatively coupled to a plurality of sensors and a user interface, the sensors being capable of continuously monitoring one or more conditions of the monitored environment and/or the operation of one or more devices in the monitored environment and providing data regarding said operation; generating an activity based behaviour pattern for the occupant(s) of the monitored environment by an activity-based behaviour component, said pattern being based on the data received from the sensor(s), said activity based behaviour component configured for adapting said activity based behaviour pattern based on updated data received from said sensor(s);
generating a personality based behaviour pattern for said occupant(s) by applying a behaviour framework to stored data relating to the occupant(s) personality and/or attitudes by a personality based analysis component, said personality based behaviour component configured for updating said behaviour framework to be applied based on one or more signals received from the user interface, and for adapting said personality based behaviour pattern based on the updated behaviour framework;
proving a control system communicatively coupled with the plurality of sensors for receiving data on the one or more devices, said control system providing the further steps of:
storing and generating rules for managing the operation of said devices,
receiving behaviour profile(s) of the occupant(s) based on said generated activity based behaviour pattern and personality based behaviour pattern;
providing an inference engine for inferring an optimal action based on said rules and behaviour patterns, the inference engine further configured for generating a control signal for implementing said action on one or more said devices or the user interface.
